(19) United States
(12) Patent Application Publication
(10) Pub. No.: US 2026/0197149 A1
(43) Pub. Date: Jul. 9, 2026

(54) CONFIGURABLE COMMUNICATION DEVICE THAT OPERATES WITH ASYMMETRIC AND SYMMETRIC DATA RATES

(71) Applicant: Infineon Technologies Americas Corp., El Segundo, CA (US)

(72) Inventors: Ragnar Hlynur JONSSON, Aliso Viejo, CA (US); Seid Alireza RAZAVI MAJOMARD, Belmont, CA (US); Sina BARKESHLI, Saratoga, CA (US)

(21) Appl. No.: 19/559,105

(22) Filed: Mar. 6, 2026

Related U.S. Application Data
(63) Continuation-in-part of application No. 19/040,884, filed on Jan. 30, 2025.
(60) Provisional application No. 63/557,119, filed on Feb. 23, 2024.
(60) Provisional application No. 63/768,830, filed on Mar. 7, 2025.

(51) Int. Cl. H04L 5/22; G06F 13/42

(52) U.S. Cl. CPC H04L 5/22; G06F 13/42

(57) ABSTRACT

An Ethernet interface selectively operates according to i) an asymmetric first mode in which transmission in a first direction and reception in a second direction occur at different data rates, and ii) a symmetric second mode in which transmission in the first direction and reception in the second direction occur at a same data rate. The Ethernet interface encodes a first bit stream to generate a first output data stream for transmission at the first data rate, and/or encodes the first bit stream to generate a second output data stream for transmission at a second data rate that is different than the first data rate. The Ethernet interface i) generates a transmit signal using the first output data stream when operating in the symmetric first mode, and ii) generates the transmit signal using the second output data stream when operating in the asymmetric second mode.

### CROSS REFERENCES TO RELATED APPLICATIONS

This application claims the benefit of U.S. Provisional Patent Application No. 63/768,830 , entitled “Full-Duplex Scheme for Asymmetric Communication Links,” filed on Mar. 7, 2025. Additionally, this application is a continuation-in-part of U.S. patent application Ser. No. 19/040,884, entitled “Full-Duplex Scheme for Asymmetric Communication Links Using Zero-Disparity Modulation,” filed on Jan. 30, 2025, which claims the benefit of U.S. Provisional Patent Application No. 63/557,119 , entitled “Frequency Division Duplexing Symmetric and Asymmetric Ethernet Links on a Single PHY,” filed on Feb. 23, 2024. The disclosures of all of the applications referenced above are hereby expressly incorporated herein by reference in their entireties for all purposes.

### FIELD OF TECHNOLOGY

The present disclosure relates generally to communication networks, and more particularly to full-duplex communication with asymmetric data rates.

### BACKGROUND

The approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Various communication systems and applications involve bidirectional communication with asymmetric data rates, in which data rates for upstream communications differ from data rates for downstream communications. For example, a communication link between a video camera and a controller typically conveys a high-data-rate signal that conveys sensor data from the camera to the controller, and a low-data-rate signal that conveys control data from the controller to the camera. Another example of an asymmetric communication link is a link connecting a processor and a display. In such a link, the data rate from the processor to the display is typically much higher than the data rate in the opposite direction.

### SUMMARY

In an embodiment, a communication device comprises an Ethernet interface device configured to selectively operate according to a plurality of modes, including i) an asymmetric first mode in which the Ethernet interface transmits to a link partner in a first direction via a cable and receives from the link partner in a second direction via the cable at different data rates, and ii) a symmetric second mode in which the Ethernet interface transmits to the link partner in the first direction via the cable and receives from the link partner in the second direction via the cable at a same data rate. The Ethernet interface device includes: a first Physical Coding Sublayer (PCS) circuit configured to perform PCS operations specified by a communication protocol corresponding to transmitting in the first direction at a first data rate, including encoding a first bit stream to generate a first output data stream for transmission at the first data rate; a framing and mapping (framing/mapping) circuit configured to encode the first bit stream to generate a second output data stream for transmission at a second data rate that is different than the first data rate; and a second PCS circuit configured to perform PCS operations specified by the communication protocol corresponding to receiving in the second direction at the first data rate, including decoding an input data stream at the first data rate. The Ethernet interface device is configured to i) generate a transmit signal using the first output data stream when operating in the symmetric first mode, and ii) generate the transmit signal using the second output data stream when operating in the asymmetric second mode.

In another embodiment, a communication system comprises: a first communication device coupled to a cable, the first communication device having a first Ethernet interface device configured to receive in a first direction via the cable and transmit in a second direction via the cable at different data rates; and a second communication device coupled to the cable, the second communication device having a second Ethernet interface device configured to selectively operate according to a plurality of modes, including i) an asymmetric first mode in which the Ethernet interface transmits in the first direction via the cable and receives in the second direction via the cable at different data rates, and ii) a symmetric second mode in which the Ethernet interface transmits in the first direction via the cable and receives in the second direction via the cable at a same data rate, wherein the second Ethernet interface device operates according to the asymmetric second mode when communicating with the first communication device via the cable. The second Ethernet interface device includes: a first PCS circuit configured to perform PCS operations specified by a communication protocol corresponding to transmitting in the first direction at a first data rate, including encoding a first bit stream to generate a first output data stream for transmission at the first data rate; a framing and mapping (framing/mapping) circuit configured to encode the first bit stream to generate a second output data stream for transmission at a second data rate that is different than the first data rate; and a second PCS circuit configured to perform PCS operations specified by the communication protocol corresponding to receiving in the second direction at the first data rate, including decoding an input data stream at the first data rate. The second Ethernet interface device is configured to i) generate a transmit signal using the first output data stream when operating in the symmetric first mode, and ii) generate the transmit signal using the second output data stream when operating in the asymmetric second mode.

In yet another embodiment, a method is for operating a communication device that includes an Ethernet interface device having i) a first PCS circuit configured to perform PCS operations specified by a communication protocol corresponding to transmitting via a cable in a first direction at a first data rate, including encoding a first bit stream to generate a first output data stream for transmission at the first data rate, and ii) a framing and mapping (framing/mapping) circuit configured to encode the first bit stream to generate a second output data stream for transmission at a second data rate that is different than the first data rate. The method includes: determining, at the communication device, a selected mode of operation from amongst multiple modes of operation according to which the Ethernet interface device is configured to operate, the multiple modes of operation including i) an asymmetric first mode in which the Ethernet interface transmits in the first direction via the cable and receives from the link partner in a second direction via the cable at different data rates, and ii) a symmetric second mode in which the Ethernet interface transmits to the link partner in the first direction via the cable and receives from the link partner in the second direction via the cable at a same data rate; selecting, by the Ethernet interface device and according to the selected mode of operation, a selected data stream, from amongst multiple data streams, for transmission via the cable in the first direction, the multiple data streams including i) the first output data stream corresponding to an output of the first PCS circuit, and ii) the second output data stream corresponding to an output of the framing/mapping circuit; and receiving, by the Ethernet interface device, a receive signal via the cable in the second direction.

### BRIEF DESCRIPTION OF THE DRAWINGS

FIG. 1 is a block diagram that schematically illustrates an example asymmetric automotive Ethernet link, in accordance with an embodiment that is described herein.

FIG. 2 is a block diagram that schematically illustrates an example internal configuration of a camera-side physical Layer (PHY) device in the link of FIG. 1, in accordance with an embodiment that is described herein.

FIG. 3 is a flow diagram that schematically illustrates an example method for asymmetric Ethernet communication, in accordance with an embodiment that is described herein.

FIG. 4 is a block diagram that schematically illustrates an example Low-Speed (LS) receiver in the camera-side PHY device of FIG. 1, in accordance with an embodiment that is described herein.

FIG. 5 is a block diagram that schematically illustrates an example High-Speed (HS) transmitter in the camera-side PHY device of FIG. 1, in accordance with an embodiment that is described herein.

FIG. 6 is a block diagram that schematically illustrates an example camera-side PHY device, in accordance with an embodiment that is described herein.

FIG. 7 is a block diagram that schematically illustrates an example central (switch-side) PHY device, in accordance with an embodiment that is described herein.

FIG. 8 is a block diagram that schematically illustrates an example camera-side PHY device, in accordance with an alternative embodiment that is described herein.

FIG. 9 is a graph illustrating spectra of HS and LS signals in the camera-side PHY device of FIG. 8, in accordance with an alternative embodiment that is described herein.

FIG. 10 is a flow diagram that schematically illustrates an example method for operating a communication device, in accordance with an embodiment that is described herein.

### DETAILED DESCRIPTION

Embodiments that are described herein provide improved techniques for multiplexing signals transmitted in opposite directions over a shared communication link. The embodiments disclosed herein are described mainly in the context of an asymmetric Ethernet link that connects a camera or other sensor to a switch or other central controller in an automotive Ethernet communication system. This choice, however, is made solely by way of example. In alternative embodiments, the disclosed techniques can be used in any other suitable system, application and/or with any other suitable communication protocol involving asymmetric communication. Non-limiting examples of alternative applications include industrial and enterprise networks.

In some embodiments, an automotive Ethernet communication link comprises two Ethernet physical layer (PHY) devices that communicate over an Ethernet cable. One PHY device is connected to a camera or other sensor, and is referred to as a “camera-side” or “sensor-side” PHY device. The other PHY device is connected to a switch or central controller, and is referred to as a “switch-side” or “central” PHY device. The Ethernet signal transmitted by the camera-side PHY device is referred to as a “High-Speed” (HS) signal, and the Ethernet signal transmitted by the switch-side PHY device is referred to as a “Low-Speed” (LS) signal. In one example embodiment, the data rate of the HS signal is 5 Gbps, while the data rate of the LS signal is 100 Mbps.

In the disclosed embodiments, the HS PHY device and the LS PHY device transmit the HS signal and the LS signal concurrently over the cable. The LS signal has a considerably narrower spectrum than the HS signal. When both signals are transmitted concurrently, the spectrum of the LS signal typically overlaps the lower part of the spectrum of the HS signal. Unless accounted for, the overlap in spectrum may cause interference between the two signals.

In some embodiments, the interference between the HS signal and the LS signal is reduced by proper design of the modulation scheme of the HS signal. In the embodiments described herein, the HS signal is modulated using a zero-disparity modulation. In the present context, the term “zero-disparity modulation” refers to a modulation scheme in which the modulated signal has a spectral notch in the vicinity of zero frequency (0 Hz, also referred to as “Direct Current”-DC). Equivalently, the term “zero-disparity modulation” can be defined as a modulation scheme in which the modulated signal has an average amplitude of zero (or that approaches zero). One example of zero-disparity modulation is bipolar Non-Return-to-Zero (bipolar NRZ). Another example is Manchester-code modulation. Yet another example is Pulse-Amplitude Modulation (PAM) followed by High-Pass Filtering (HPF). All three examples are described in detail below. Alternatively, any other suitable zero-disparity modulation can be used.

When using zero-disparity modulation for the HS signal, the spectrum of the LS signal falls in a spectral region in which the HS signal has very low power content. As a result, interference in both directions (interference from the LS signal to demodulation of the HS signal, and interference from the HS signal to demodulation of the LS signal) is reduced considerably.

The disclosed multiplexing scheme is superior to conventional schemes such as Frequency-Division Multiplexing (FDD) and Time-Division Multiplexing (TDD), for example with regards to the cost, size and simplicity of design of the PHY devices. Unlike FDD, the disclosed multiplexing scheme uses the spectral shapes of the signals to distinguish between the signals transmitted in the two link directions, and therefore obviates the need for strict frequency separation and filtering between the HS signal and the LS signal. Unlike TDD, the multiplexing scheme described herein enables continuous concurrent transmission of the two signals (“full-duplex”) and has no need for switching and timing circuitry. Moreover, the low levels of interference between the HS signal and the LS signal eliminate the need for echo cancellation in the PHY devices. The disclosed PHY devices are therefore simpler to implement and have low cost, size and power consumption.

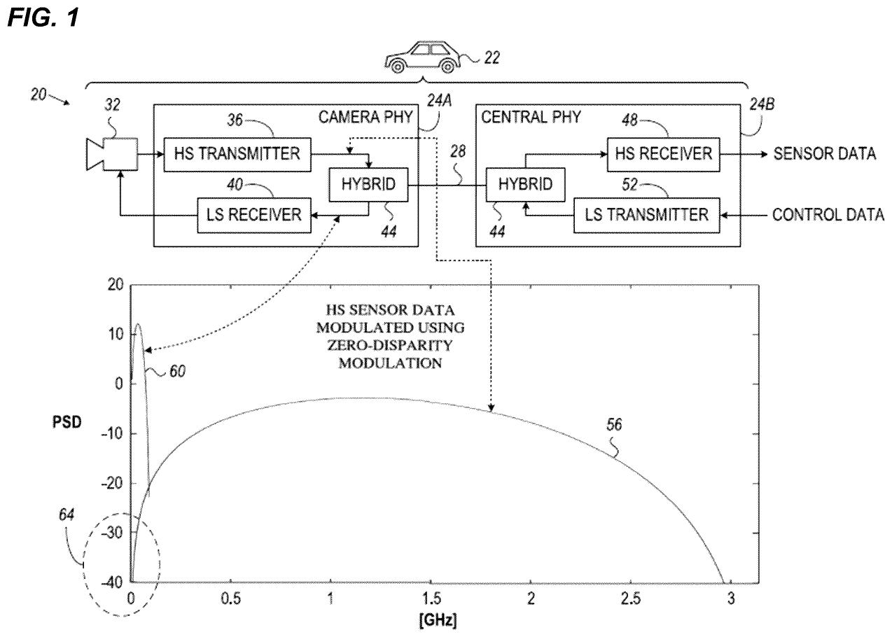

FIG. 1 is a block diagram that schematically illustrates an asymmetric automotive Ethernet link 20, in accordance with an embodiment that is described herein. Link 20 is typically installed in a vehicle 22, as part of an automotive Ethernet communication system. In alternative embodiments, link 20 may be used in any other suitable system or application such as industrial or enterprise networks. Link 20 comprises a pair of Ethernet PHY devices 24A and 24B that communicate over an Ethernet cable 28. Cable 28 may comprise, for example, a twisted-pair automotive Ethernet cable or any other suitable medium that is shared between both transmission directions of the link.

In the present example, PHY device 24A (“camera-side PHY”) is connected locally to a camera 32, and PHY device 24B (“central PHY”) is connected locally to a port of a switch or central controller. PHY device 24A receives sensor data (e.g., video data) from camera 32, generates a HS signal that conveys the sensor data, and transmits the HS signal over cable 28 to PHY device 24B. PHY device 24B receives control data for controlling camera 32, e.g., from the central controller, generates a LS signal that conveys the control data, and transmits the LS signal over cable 28 to PHY device 24A.

In the embodiment of FIG. 1, camera-side PHY device 24A comprises an HS transmitter 36, an LS receiver 40, and a hybrid 44. Hybrid 44 serves as a cable interface for both transmission and reception. HS transmitter 36 obtains the sensor data from camera 32, generates the HS signal (including modulating the sensor data using zero-disparity modulation as described below), and transmits the HS signal via hybrid 44 over cable 28. LS receiver 40 receives the LS signal from the cable via hybrid 44, demodulates the LS signal and forwards the control data to camera 32.

In the example of FIG. 1, central PHY device 24B comprises an HS receiver 48, an LS transmitter 52, and a hybrid 44. HS receiver 48 receives the HS signal from cable 28 via hybrid 44, demodulates the HS signal and forwards the sensor data to its locally connected switch or central controller. LS transmitter 52 obtains the control data from the switch or central controller, generates the LS signal, and transmits the LS signal via hybrid 44 over cable 28.

A graph at the bottom of FIG. 1 illustrates the spectra of the HS and LS signals, in an embodiment. The vertical axis denotes Power Spectral Density (PSD) in arbitrary logarithmic units. The horizontal axis denotes frequency in GHz. A plot 56 shows the spectrum of the HS signal transmitted by HS transmitter 36 (in camera-side PHY device 24A). A plot 60 shows the spectrum of the LS signal transmitted by LS transmitter 52 (in central PHY device 24B).

As seen, the HS signal and the LS signal partially overlap in spectrum: Spectrum 60 of the LS signal coincides with the lower part of spectrum 56 of the HS signal. To reduce the level of interference between the two signals, given the partial overlap, the modulation scheme used in the HS signal has a spectral notch 64 in the vicinity of DC (zero frequency). Notch 64 is achieved by modulating the sensor data using zero-disparity modulation in which the DC component typically diminishes to zero. In various embodiments, HS transmitter 36 may modulate the sensor data using any suitable type of zero-disparity modulation.

In one embodiment, HS transmitter 36 modulates the sensor data using bipolar NRZ modulation. In bipolar NRZ, the modulator receives a sequence of “0” and “1” bits. The “0” bits are mapped to a symbol value of zero. The “1” bits in the sequence are mapped alternately to +V and to −V. When averaged (e.g., integrated) over time, the average amplitude of the modulated signal approaches zero.

In another embodiment, HS transmitter 36 modulates the sensor data using Manchester-code modulation. In Manchester-code modulation, each individual symbol is positive during part of the symbol interval and negative during the rest of the symbol interval, so that the average amplitude of each symbol is zero. In one example, a bit value of “0” is mapped to a symbol that equals +V during the first half of the symbol interval, and transitions to −V in the second half of the symbol interval. A bit value of “1” is mapped to a symbol that equals −V during the first half of the symbol interval, and transitions to +V in the second half of the symbol interval.

In the frequency domain, the spectrum of both bipolar NRZ and Manchester-code modulation have a spectral notch similar to notch 64 in the vicinity of DC (since the average signal amplitude is substantially zero). This property reduces the interference between the HS signal and the LS signal.

In various embodiments, LS transmitter 52 (in central PHY device 24B) may use various types of modulation for modulating the control data to generate the LS signal. The modulation used for the LS signal may be but is not necessarily zero-disparity modulation. For example, in some embodiments LS transmitter 52 may use PAM (e.g., PAM-2 or PAM-4) for generating the LS signal. Alternatively, however, in some embodiments LS transmitter 52 may use zero-disparity modulation for the LS signal, as well. This implementation is useful, for example, as it reduces baseline wander effects in which the baseline level of the signal changes slowly over time. In the non-limiting example of FIG. 1, spectrum 60 is also seen to have a spectral notch at DC, caused by the use of zero-disparity modulation by LS transmitter 52.

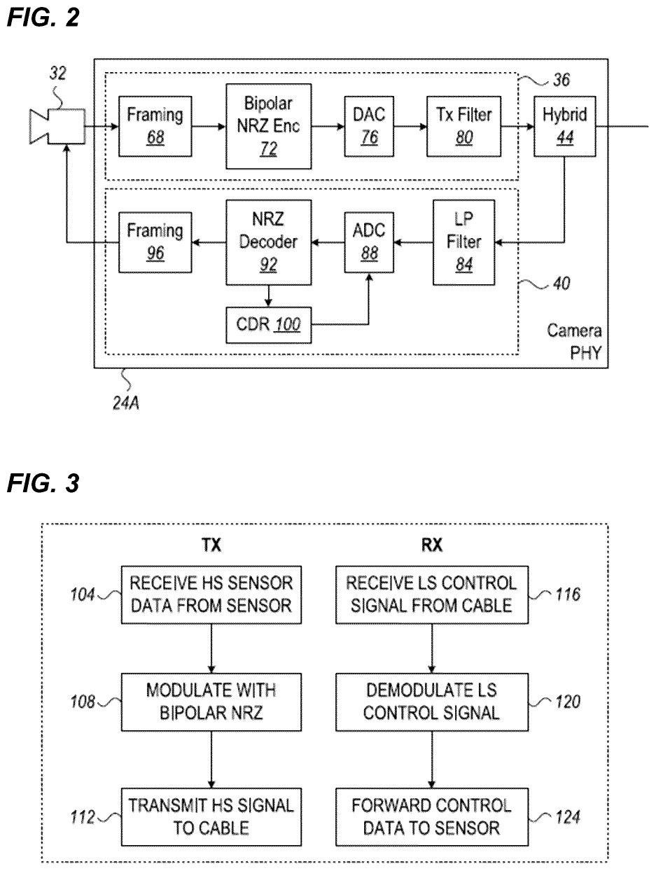

FIG. 2 is a block diagram that schematically illustrates the internal configuration of camera-side PHY device 24A, in accordance with an embodiment that is described herein.

In the present example, HS transmitter 36 comprises a framing module 68, a bipolar NRZ encoder 72, a Digital-to-Analog Converter (DAC) 76 and a transmit (Tx) filter 80. Framing module 68 formats the sensor data into frames, in some embodiments including calculation of Forward Error Correction (FEC) and Cyclic Redundancy Check (CRC) bits. Encoder 72 encodes the resulting bit stream with bipolar NRZ (i.e., maps the “0” bits to “0”s, and the “1” bits to “1” and “−1” alternately). DAC 76 converts the output of encoder 72 into an analog signal having three analog values {−V,0,+V}. Tx filter 80 filters the output of DAC 76. The resulting HS signal is transmitted over cable 28 via hybrid 44.

In the example of FIG. 2, LS receiver 40 comprises a Low-Pass (LP) filter 84, an Analog-to-Digital Converter (ADC) 88, an NRZ decoder 92, a framing module 96, and a Clock-Data Recovery (CDR) module 100. LP filter 84 applies low-pass filtering to the LS signal received from cable 28 via hybrid 44.

The spectral response of LP filter 84 is designed to pass the spectrum of the LS signal (e.g., spectrum 60 of FIG. 1), while suppressing most of the spectrum of the HS signal (e.g., spectrum 56 of FIG. 1). As explained above, spectral notch 64 reduces the amount of power of the HS signal that overlaps the LS signal. Combined with the low-pass filtering of LP filter 84, the amount of energy of the HS signal that leaks into LS receiver 40 is minimal. As a result, the interference caused by transmission of the HS signal to reception of the LS signal is minimized.

ADC 88 digitizes the filtered signal at the output of LP filter 84. NRZ decoder 92 decodes the digitized signal. Framing module 96 decodes and removes the FEC and CRC bits. The resulting control data is delivered to camera 32. CDR module 100 reconstructs the clock of the LS signal and controls the sampling clock of ADC 88.

FIG. 3 is a flow chart that schematically illustrates a method for asymmetric Ethernet communication, in accordance with an embodiment that is described herein. The method focuses on the operation of camera-side PHY device 24A. The left-hand side of the figure shows the operations relating to transmission of the HS signal. The right-hand side of the figure shows the operations relating to reception of the LS signal.

At a sensor-data reception operation 104, HS transmitter 36 receives sensor data from camera 32. At a modulation operation 108, HS transmitter 36 modulates the sensor data with bipolar NRZ modulation. At a transmission operation 112, HS transmitter 36 transmits the HS signal to cable 28.

At a control-signal reception operation 116, LS receiver 40 receives the LS signal from cable 28. At a demodulation operation 120, LS receiver 40 demodulates the LS signal so as to reproduce the control data. At a forwarding operation 124, LS receiver 40 forwards the control data to camera 32.

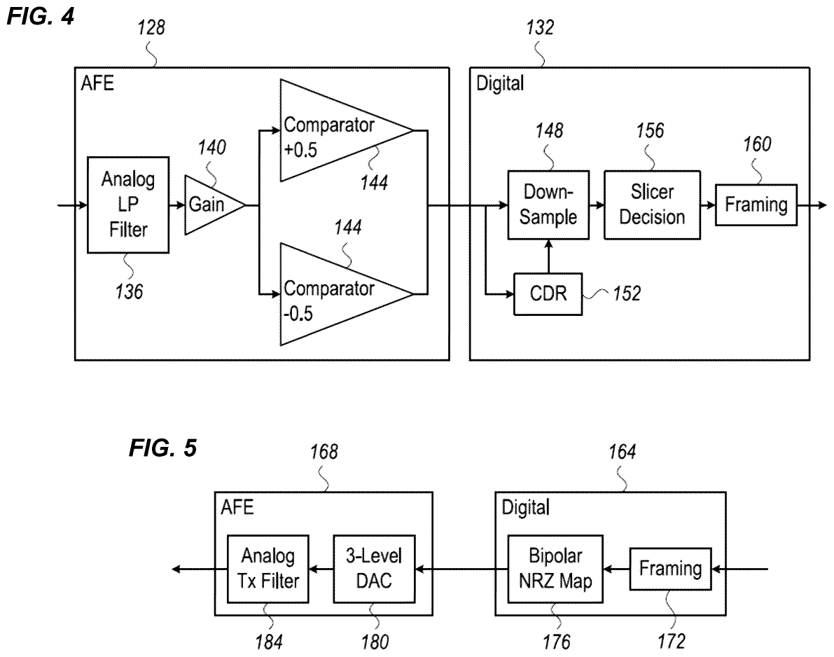

FIG. 4 is a block diagram that schematically illustrates the internal structure of an LS receiver in camera-side PHY device 24A, in accordance with another embodiment that is described herein. In the present example, the LS signal is modulated using bipolar NRZ modulation, as well. The example LS receiver of FIG. 4 comprises an Analog Front-End (AFE) 128 followed by a digital processor 132. AFE 128 comprises an analog LP filter 136, a gain block 140 and a pair of comparators 144. Digital block 132 comprises a down-sampler 148, a slicer (also referred to as a decision circuit) 156, a framing module 160, and a Clock-Data Recovery (CDR) module 152.

LP filter 136 applies low-pass filtering to the LS signal received from cable 28 (similarly to LP filter 84 of FIG. 2). As explained above, this filtering removes the vast majority of the energy of the HS signal that may leak into the LS receiver.

Gain block 140 amplifies the filtered LS signal to the proper level expected by comparators 144. Comparators 144 compare the level of the LS signal to −0.5 and to +0.5. The outputs of the two comparators are summed together. The resulting signal, at the output of AFE 128, is a sequence of analog values that takes three possible values {−V,0,+V} in accordance with the bipolar modulation of the LS signal.

Down-sampler 148 samples the output of AFE 128 at a rate of one sample per symbol (i.e., at the symbol rate of the LS signal). Slicer 156 decides, for each sample produced by down-sampler 148, whether the sample represents “1”, “0” or “−1”. Framing module 160 operates similarly to framing module 96 of FIG. 2.

FIG. 5 is a block diagram that schematically illustrates the internal structure of a HS transmitter in camera-side PHY device 24A, in accordance with another embodiment that is described herein. In this implementation, the HS transmitter comprises a digital processor 164 followed by an AFE 168. Digital processor 164 comprises a framing module 172 and a bipolar NRZ mapper 176. AFE 168 comprises a 3-level DAC 180 and an analog Tx filter 184.

Framing module 172 receives the sensor data from camera 32 and frames the data, similarly to framing module 68 of FIG. 2. Mapper 176 maps the framed sensor data into a sequence of {−1,0,1} values in accordance with bipolar NRZ, in an embodiment. DAC 180 converts the {−1,0,1} values into respective analog values. Tx filter 185 filters the output of DAC 180, similarly to filter 80 of FIG. 2. The resulting HS signal is transmitted over cable 28 via hybrid 44. In alternative embodiments, other suitable types of HS modulation can be used, and the HS transmitter may have any other suitable configuration.

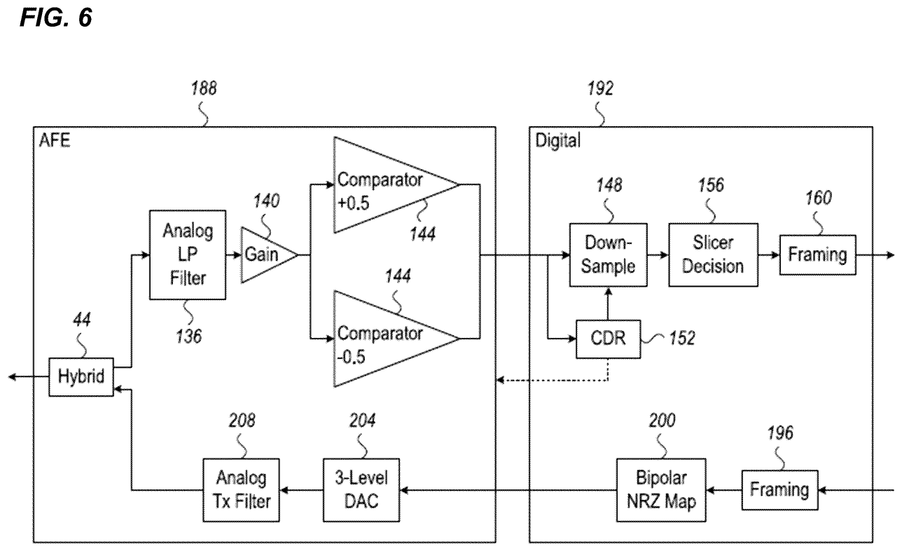

FIG. 6 is a block diagram that schematically illustrates a camera-side PHY device, in accordance with an embodiment that is described herein. The camera-side PHY device of FIG. 6 comprises an AFE 188 and a digital processor 192. In addition to a hybrid 44, AFE 188 comprises transmission circuitry that is similar to AFE 128 of FIG. 4 (comprising a LP filter 136, a gain block 140 and comparators 144), and reception circuitry that is similar to AFE 168 of FIG. 5 (comprising a 3-level DAC 204 and an analog TX filter 208). Digital processor 192 comprises transmission circuitry that is similar to digital processor 132 of FIG. 4 (comprising a down-sampler 148, a slicer 156, a framing module 160 and a CDR module 152), and reception circuitry that is similar to digital processor 164 of FIG. 5 (comprising a framing module 196 and a bipolar NRZ mapper 200).

In the configuration of FIG. 6, the transmission clock may be independent of the reception clock.

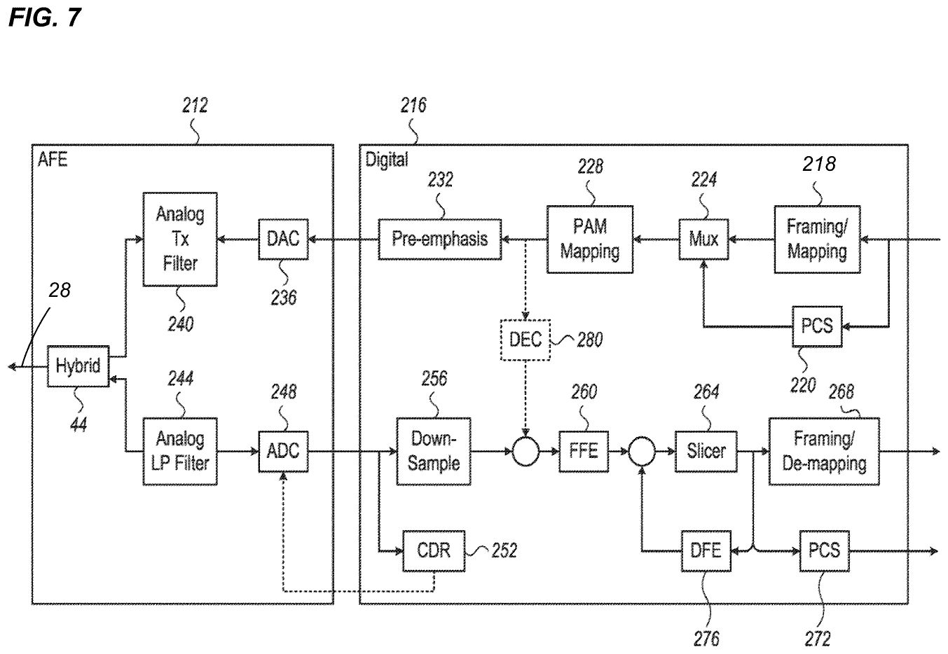

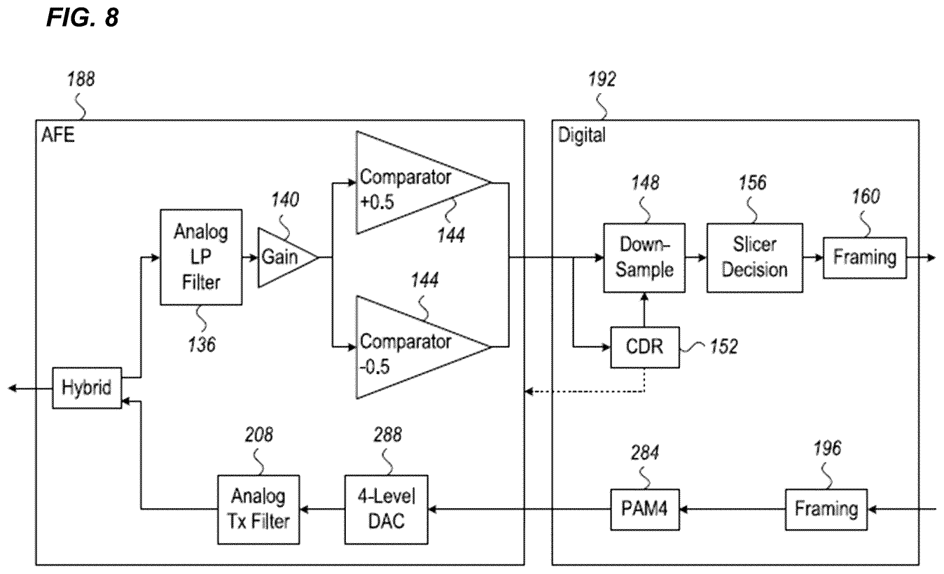

FIG. 7 is a simplified block diagram of an example communication device 24B, in accordance with an embodiment that is described herein. The communication device 24B is configured to operate according to multiple different operating modes, including i) a first mode in which a transmit data rate is equal to a receive data rate, and ii) a second mode in which the transmit data rate is less than the receive data rate, according to an embodiment. The multiple different operating modes includes i) a first mode corresponding to an IEEE 802.3 Standard (such as the IEEE 802.3ch Standard or another suitable IEEE 802.3 Standard) that specifies a transmit data rate equal to a receive data rate, and ii) a second mode in which the transmit data rate is less than the receive data rate, according to an embodiment.

In an embodiment, the communication device 24B of FIG. 7 corresponds to the central PHY device 24B of FIG. 1, in an embodiment. In an embodiment, the communication device 24B is configured to communicate with another communication device (not shown in FIG. 7) in a first mode corresponding to an IEEE 802.3 Standard (such as the IEEE 802.3ch Standard or another suitable IEEE 802.3 Standard) that specifies a transmit data rate equal to a receive data rate. Additionally, the communication device 24B is configured to communicate with the Ethernet PHY device 24A of FIG. 1 in a second mode in which a data rate in a first direction from the communication device 24B to the Ethernet PHY device 24A is less than a data rate in a second direction from the Ethernet PHY device 24A to the communication device 24B, in an embodiment.

PHY device 24B comprises an AFE 212 and a digital processor 216. In the present example, the LS signal is modulated using conventional PAM, while the HS signal is modulated using bipolar NRZ.

The transmission circuitry in digital processor 216 comprises a framing/mapping module 218 and a Physical Coding Sublayer (PCS) module 220. The framing/mapping module 218 is configured to encode an input bit stream into an output data stream to be provided to a PAM mapping module 228. The framing/mapping module 218 is configured to operate according to a data rate that is less than a data rate at which the communication device 24B receives data via the cable 28. In an embodiment, the framing/mapping module 218 is configured to receive the input bit stream and generate a higher rate data stream according to bipolar NRZ. In an embodiment, framing/mapping module 218 repeats incoming “1” bits as “+3” and “−3”, and converts incoming “0” bits into an alternating .sequence of “+l”s and “−l”s.

On the other hand, the PCS module 220 is configured to perform PCS operations as specified by the IEEE 802.3ch Standard or another suitable IEEE 802.3 Standard. In an embodiment, the PCS operations performed by the PCS module 220 include encoding the input bit stream to generate an output data stream to be provided to a PAM mapping module 228. The PCS module 220 is configured to operate according to a data rate that is equal to a data rate at which the communication device 24B receives data via a cable.

Output streams of the framing/mapping module 218 and the PCS module 220 are selected by a multiplexer 224 (or a switch) to be provided to the PAM mapping module 228.

The PAM mapping module 228 outputs a sequence of digital PAM symbols based on an output stream received from the multiplexer 224. A pre-emphasis filter 232 filters the sequence of PAM symbols. In an embodiment, pre-emphasis filter 232 comprises an even-length symmetric LP filter. The transmission circuitry in AFE 212 comprises a DAC 236 that converts the digital PAM signal into an analog PAM signal, and an analog Tx filter 240 that filters the analog PAM signal. The output of filter 240 is transmitted via hybrid 44 to cable 28.

The reception circuitry in AFE 212 comprises an analog LP filter 244 that filters the HS signal received via hybrid 44 from cable 28. An ADC 248 digitizes the HS signal received via hybrid 44 from cable 28. In digital processor 216, the reception circuitry comprises a CDR module 252 that recovers the HS signal clock and controls the sampling clock of ADC 248. A down-sampler 256 reduces the rate of the digitized HS signal to one sample per symbol. A Feed-Forward Equalizer (FFE) 260 and a Decision-Feedback Equalizer (DFE) 276 equalizes the signal. Equalizers 260 and 276 typically comprise digital filters having adaptive coefficients (taps) Alternatively, other suitable types of equalizers can be used. A slicer 264 makes bit decisions.

A framing and de-mapping module 268 and a PCS module 272 receive a data stream output by the slicer 264. The framing and de-mapping module 268 is configured to decode the data stream output by the slicer 264 into an output bit stream when the communication device 24B is operating according to the second mode in which the data rate in the first direction from the communication device 24B to the Ethernet PHY device 24A is less than the data rate in the second direction from the Ethernet PHY device 24A to the communication device 24B. Thus, the framing and de-mapping module 268 is configured to operate according to a data rate that is higher than a data rate at which the communication device 24B transmits data via the cable 28 in the second mode of operation.

On the other hand, the PCS module 272 is configured to perform PCS operations as specified by the IEEE 802.3ch Standard or another suitable IEEE 802.3 Standard when the communication device 24B is operating according to the first mode corresponding to an IEEE 802.3 Standard (such as the IEEE 802.3ch Standard or another suitable IEEE 802.3 Standard) that specifies a transmit data rate equal to a receive data rate. In an embodiment, the PCS operations performed by the PCS module 272 include decoding the output of the slicer 264 into an output bit stream.

In some embodiments, a Digital Echo Cancellation (DEC) module 280 cancels echoes of the transmitted LS signal from the received HS signal. In alternative embodiments, analog echo cancellation can be used. In yet other embodiments, the reception performance of PHY device 24B is sufficient without echo cancellation, and echo cancellation module 280 is omitted.

In operation, when the communication device 24B is to be used in a communication system in which the communication device 24B operates according to the first mode, the multiplexer 224 is configured to select the output of the PCS module 220 to be provided to the PAM mapping module 228; and the output bitstream of the PCS module 272 is utilized; optionally, the framing and de-mapping module 218 and/or the framing and de-mapping module 268 are powered down to save power.

On the other hand, when the communication device 24B is to be used in a communication system in which the communication device 24B operates according to the second mode, the multiplexer 224 is configured to select the output of the framing/mapping module 218 to be provided to the PAM mapping module 228; and the output bitstream of the framing and de-mapping module 268 is utilized; optionally, the PCS module 220 and/or the PCS module 272 are powered down to save power.

Central PHY device 24B of FIG. 1 can be implemented while making use of certain elements of a conventional IEEE 802.3ch-compatible PHY device. Certain blocks (e.g., framing/mapping module 218, the framing and de-mapping module 268, and the multiplexer 224) may be new, while other elements may need modifications. In some embodiments, certain elements (e.g., analog LP filter 244 and/or DFE 276) can be omitted. In the configuration of FIG. 7, the transmission clock and the reception clock may be locked to one another, at least in some scenarios.

In an embodiment, in the second mode of operation the data rate in the second direction from the Ethernet PHY device 24A to the communication device 24B is the same as or similar to a data rate specified by an IEEE 802.3 Standard (such as the IEEE 802.3ch Standard or another suitable IEEE 802.3 Standard), and the output bitstream of the PCS module 272 can also be used in the second mode of operation. Thus, in some embodiments, the framing and de-mapping module 268 is omitted.

Although FIG. 7 was described in the context of the second mode of operation in which the data rate in the first direction from the communication device 24B to the Ethernet PHY device 24A is less than the data rate in the second direction from the Ethernet PHY device 24A to the communication device 24B, in other embodiments the second mode of operation involves transmitting according to a data rate in the first direction from the communication device 24B to the Ethernet PHY device 24A that is higher than a data rate in the second direction from the Ethernet PHY device 24A to the communication device 24B.

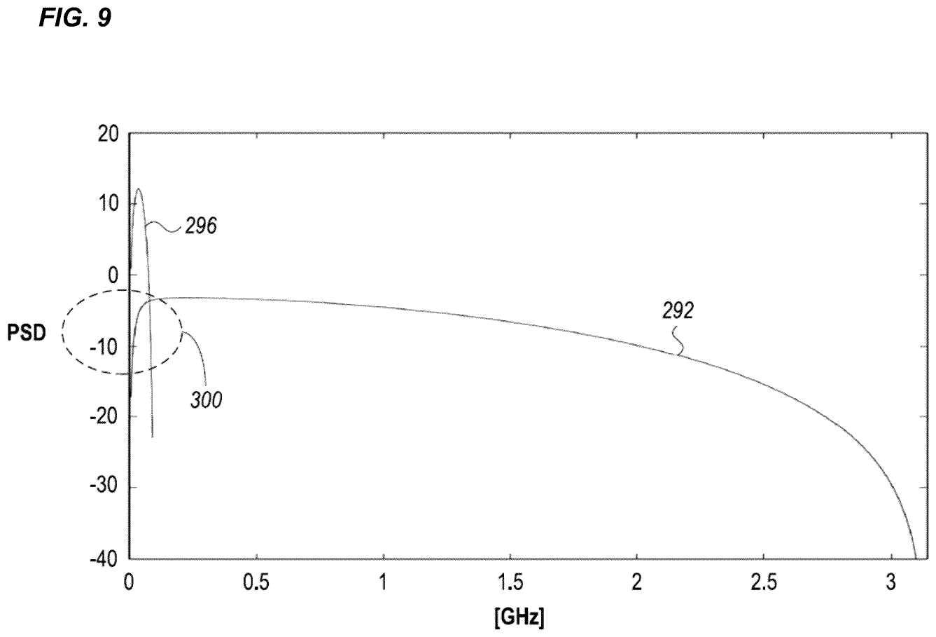

FIG. 8 is a block diagram that schematically illustrates a camera-side PHY device, in accordance with an alternative embodiment that is described herein. In this example, the HS signal is modulated using PAM-4, and the spectral notch in the vicinity of DC is produced by analog filtering of the PAM-4 signal. The resulting signal spectrum is illustrated in FIG. 9 below. Alternatively, digital filtering can be used.

In the present example, the internal structure of PHY device 24A is similar to that of FIG. 6 above. The PHY device of FIG. 8 differs from that of FIG. 6 in the following:
Digital processor 192 comprises a PAM-4 mapper 284 instead of bipolar NRZ mapper 200.
AFE 188 comprises a 4-level DAC 288 instead of 3-level DAC 204.

In some embodiments, when using PAM-4 modulation followed by high-pass filtering for the HS signal, central PHY device 24B can be similar to that of FIG. 7 above.

FIG. 9 is a graph illustrating spectra of the transmitted HS signal and the received LS signal in the camera-side PHY device of FIG. 8, in accordance with an alternative embodiment that is described herein. The vertical axis denotes Power Spectral Density (PSD) in arbitrary logarithmic units. The horizontal axis denotes frequency. A plot 292 shows the spectrum of the HS signal transmitted by the HS transmitter 36. A plot 296 shows the spectrum of the LS signal received by the LS receiver. As seen, spectrum 292 of the HS signal has a spectral notch 300 in the vicinity of zero frequency. This notch is created by the high-pass filtering operation of analog Tx filter 208 (FIG. 8).

The configurations of the various communication links and PHY devices shown in FIGS. 1-8, and their components such as the HS and LS transmitters and receivers, are example configurations that are depicted solely for the sake of clarity. In alternative embodiments, any other suitable configurations can be used.

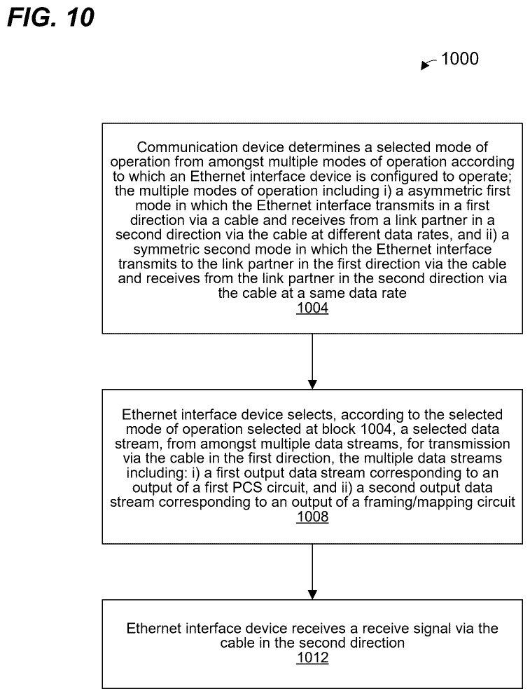

FIG. 10 is a flow diagram of an example method 1000 for operating a communication device that includes an Ethernet interface device configured to operate in an asymmetric first mode of operation and a symmetric second mode of operation, according to an embodiment. In an embodiment, the communication device that performs the method 1000 comprises i) a first PCS circuit configured to perform PCS operations specified by a communication protocol corresponding to transmitting via a cable in a first direction at a first data rate, and ii) a framing and mapping (framing/mapping) circuit configured to encode the first bit stream to generate a second output data stream for transmission at a second data rate that is different than the first data rate. The first PCS circuit is configured to encode a first bit stream to generate a first output data stream for transmission at the first data rate.

At block 1004, the communication device determines a selected mode of operation from amongst multiple modes of operation according to which the Ethernet interface device is configured to operate. The multiple modes of operation includes i) the asymmetric first mode in which the Ethernet interface transmits in the first direction via the cable and receives from the link partner in a second direction via the cable at different data rates, and ii) the symmetric second mode in which the Ethernet interface transmits to the link partner in the first direction via the cable and receives from the link partner in the second direction via the cable at a same data rate.

At block 1008, the Ethernet interface device selects, according to the selected mode of operation selected at block 1004, a selected data stream, from amongst multiple data streams, for transmission via the cable in the first direction, the multiple data streams including: i) the first output data stream corresponding to an output of the first PCS circuit, and ii) the second output data stream corresponding to an output of the framing/mapping circuit.

At block 1008, the Ethernet interface device receives a receive signal via the cable in the second direction.

In an embodiment, the second data rate is lower than the first data rate. In another embodiment, the second data rate is higher than the first data rate.

In an embodiment, selecting the selected data stream at block 1008 comprises selecting, by a selection circuit of the Ethernet network device, between i) the first output data stream of the first PCS circuit, and ii) the second output data stream of the framing/mapping circuit.

In another embodiment, the Ethernet interface device further includes a framing and de-mapping (framing/de-mapping) circuit configured to decode the input data stream at a third data rate; and the method 1000 further comprises selecting, by the Ethernet interface device and according to the selected mode of operation selected at block 1004, a selected bit stream, from amongst multiple bits streams, for processing by the Ethernet interface device, the multiple bit streams including: a first output bit stream of the second PCS circuit corresponding to receiving in the second direction at the first data rate, and a second output of the framing/de-mapping circuit corresponding to receiving in the second direction at the third data rate.

In another embodiment, the method 100 further includes generating, by a four-level pulse amplitude modulation (PAM4) modulator circuit, a digital transmit signal using the selected data stream.

The various elements of the disclosed communication links and PHY devices may be implemented using dedicated hardware or firmware, such as using hard-wired or programmable logic, e.g., in one or more Application-Specific Integrated Circuits (ASIC) or Field-Programmable Gate Arrays (FPGA). Additionally, or alternatively, certain elements of the disclosed communication links and PHY devices may be implemented in software and/or using a combination of hardware and software elements. Elements that are not mandatory for understanding of the disclosed techniques have been omitted from the figure for the sake of clarity.

In some embodiments, certain functions of the disclosed communication links and PHY devices may be implemented in one or more programmable processors, e.g., one or more Central Processing Units (CPUs) or microcontrollers, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

Although the embodiments described herein mainly address automotive Ethernet links, the methods and systems described herein can also be used in other applications involving bidirectional communication with asymmetric data rates.

At least some of the various blocks, operations, and techniques described above are suitably implemented utilizing dedicated hardware, such as one or more of discrete components, an integrated circuit, an application-specific integrated circuit (ASIC), a programmable logic device (PLD), a processor executing firmware instructions, a processor executing software instructions, or any combination thereof. When implemented utilizing a processor executing software or firmware instructions, the software or firmware instructions may be stored in any suitable computer readable memory such a read-only memory (ROM), a random-access memory (RAM), etc. The software or firmware instructions may include machine readable instructions that, when executed by one or more processors, cause the one or more processors to perform various acts.

It is noted that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

What is claimed is:

1. A communication device, comprising:
an Ethernet interface device configured to selectively operate according to a plurality of modes, including i) an asymmetric first mode in which the Ethernet interface transmits to a link partner in a first direction via a cable and receives from the link partner in a second direction via the cable at different data rates, and ii) a symmetric second mode in which the Ethernet interface transmits to the link partner in the first direction via the cable and receives from the link partner in the second direction via the cable at a same data rate, the Ethernet interface device including:
a first Physical Coding Sublayer (PCS) circuit configured to perform PCS operations specified by a communication protocol corresponding to transmitting in the first direction at a first data rate, including encoding a first bit stream to generate a first output data stream for transmission at the first data rate,
a framing and mapping (framing/mapping) circuit configured to encode the first bit stream to generate a second output data stream for transmission at a second data rate that is different than the first data rate, and
a second PCS circuit configured to perform PCS operations specified by the communication protocol corresponding to receiving in the second direction at the first data rate, including decoding an input data stream at the first data rate;
wherein the Ethernet interface device is configured to i) generate a transmit signal using the first output data stream when operating in the symmetric first mode, and ii) generate the transmit signal using the second output data stream when operating in the asymmetric second mode.

2. The communication device of claim 1, wherein the second data rate is lower than the first data rate.

3. The communication device of claim 1, wherein the second data rate is higher than the first data rate.

4. The communication device of claim 1, wherein the Ethernet interface device further includes:
a selection circuit configured to select between i) the first output data stream of the first PCS circuit, and ii) the second output data stream of the framing/mapping circuit;
wherein the Ethernet interface device is configured to control the selection circuit to i) select the first output data stream of the first PCS circuit when operating in the first symmetric mode, and ii) select the second output data stream of the framing/mapping circuit when operating in the second asymmetric mode.

5. The communication device of claim 1, wherein:
the Ethernet interface device further includes a framing and de-mapping (framing/de-mapping) circuit configured to decode the input data stream at a third data rate; and
the Ethernet interface device is configured to i) use an output of the second PCS circuit when operating in the symmetric first mode, and ii) use an output of the framing/de-mapping circuit when operating in the asymmetric second mode.

6. The communication device of claim 1, wherein the Ethernet interface device is configured to use an output of the second PCS circuit i) when operating in the symmetric first mode, and ii) when operating in the asymmetric second mode.

7. The communication device of claim 1, wherein the Ethernet interface device further includes a four-level pulse amplitude modulation (PAM4) modulator; and
wherein the Ethernet interface device is configured to use the PAM4 modulator to generate a digital transmit signal i) when operating in the symmetric first mode, and ii) when operating in the asymmetric second mode.

8. The communication device of claim 1, wherein the Ethernet interface device further includes analog front end (AFE) circuitry configured to:
generate an analog transmit signal for transmission via the cable in the first direction using a digital transmit signal generated by the Ethernet interface device; and
generate a digital receive signal based on an analog receive signal received via the cable in the second direction.

9. A communication system, comprising:
a first communication device coupled to a cable, the first communication device having a first Ethernet interface device configured to receive in a first direction via the cable and transmit in a second direction via the cable at different data rates; and
a second communication device coupled to the cable, the second communication device having a second Ethernet interface device configured to selectively operate according to a plurality of modes, including i) an asymmetric first mode in which the Ethernet interface transmits in the first direction via the cable and receives in the second direction via the cable at different data rates, and ii) a symmetric second mode in which the Ethernet interface transmits in the first direction via the cable and receives in the second direction via the cable at a same data rate, wherein the second Ethernet interface device operates according to the asymmetric second mode when communicating with the first communication device via the cable, the second Ethernet interface device including:
a first Physical Coding Sublayer (PCS) circuit configured to perform PCS operations specified by a communication protocol corresponding to transmitting in the first direction at a first data rate, including encoding a first bit stream to generate a first output data stream for transmission at the first data rate,
a framing and mapping (framing/mapping) circuit configured to encode the first bit stream to generate a second output data stream for transmission at a second data rate that is different than the first data rate, and
a second PCS circuit configured to perform PCS operations specified by the communication protocol corresponding to receiving in the second direction at the first data rate, including decoding an input data stream at the first data rate;
wherein the second Ethernet interface device is configured to i) generate a transmit signal using the first output data stream when operating in the symmetric first mode, and ii) generate the transmit signal using the second output data stream when operating in the asymmetric second mode.

10. The communication system of claim 9, wherein the second data rate is lower than the first data rate.

11. The communication system of claim 9, wherein the second data rate is higher than the first data rate.

12. The communication system of claim 9, wherein the second Ethernet interface device further includes:
a selection circuit configured to select between i) the first output data stream of the first PCS circuit, and ii) the second output data stream of the framing/mapping circuit;
wherein the second Ethernet interface device is configured to control the selection circuit to i) select the first output data stream of the first PCS circuit when operating in the first symmetric mode, and ii) select the second output data stream of the framing/mapping circuit when operating in the second asymmetric mode.

13. The communication system of claim 9, wherein:
the second Ethernet interface device further includes a framing and de-mapping (framing/de-mapping) circuit configured to decode the input data stream at a third data rate; and
the second Ethernet interface device is configured to i) use an output of the second PCS circuit when operating in the symmetric first mode, and ii) use an output of the framing/de-mapping circuit when operating in the asymmetric second mode.

14. The communication system of claim 9, wherein the second Ethernet interface device is configured to use an output of the second PCS circuit i) when operating in the symmetric first mode, and ii) when operating in the asymmetric second mode.

15. A method for operating a communication device that includes an Ethernet interface device having i) a first Physical Coding Sublayer (PCS) circuit configured to perform PCS operations specified by a communication protocol corresponding to transmitting via a cable in a first direction at a first data rate, including encoding a first bit stream to generate a first output data stream for transmission at the first data rate, and ii) a framing and mapping (framing/mapping) circuit configured to encode the first bit stream to generate a second output data stream for transmission at a second data rate that is different than the first data rate, the method comprising:
determining, at the communication device, a selected mode of operation from amongst multiple modes of operation according to which the Ethernet interface device is configured to operate, the multiple modes of operation including i) an asymmetric first mode in which the Ethernet interface transmits in the first direction via the cable and receives from the link partner in a second direction via the cable at different data rates, and ii) a symmetric second mode in which the Ethernet interface transmits to the link partner in the first direction via the cable and receives from the link partner in the second direction via the cable at a same data rate;
selecting, by the Ethernet interface device and according to the selected mode of operation, a selected data stream, from amongst multiple data streams, for transmission via the cable in the first direction, the multiple data streams including:
the first output data stream corresponding to an output of the first PCS circuit, and
the second output data stream corresponding to an output of the framing/mapping circuit; and
receiving, by the Ethernet interface device, a receive signal via the cable in the second direction.

16. The method of claim 15, wherein the second data rate is lower than the first data rate.

17. The method of claim 15, wherein the second data rate is higher than the first data rate.

18. The method of claim 15, wherein selecting the selected data stream from amongst multiple data streams comprises:
selecting, by a selection circuit of the Ethernet network device, between i) the first output data stream of the first PCS circuit, and ii) the second output data stream of the framing/mapping circuit.

19. The method of claim 15, wherein the Ethernet interface device further includes a framing and de-mapping (framing/de-mapping) circuit configured to decode the input data stream at a third data rate; and
the method further comprises selecting, by the Ethernet interface device and according to the selected mode of operation, a selected bit stream, from amongst multiple bits streams, for processing by the Ethernet interface device, the multiple bit streams including:
a first output bit stream of the second PCS circuit corresponding to receiving in the second direction at the first data rate, and
a second output of the framing/de-mapping circuit corresponding to receiving in the second direction at the third data rate.

20. The method of claim 15, further comprising:
generating, by a four-level pulse amplitude modulation (PAM4) modulator circuit, a digital transmit signal using the selected data stream.
